(19) United States
(12) Patent Application Publication
(10) Pub. No.: US 2018/0137616 A1
(43) Pub. Date: May 17, 2018

(54) METHOD OF IMAGE SEGMENTATION

(71) Applicant: COMPAGNIE GENERALE DES ETABLISSEMENTS MICHELIN, CLERMONT-FERRAND (FR)

(72) Inventors: VINCENT ARVIS, Clermont-Ferrand (FR); JOHN CHAUSSARD, Clermont-Ferrand (FR); MICHEL BILODEAU, Clermont-Ferrand (FR)

(21) Appl. No.: 15/736,595

(22) PCT Filed: Jun. 28, 2016
(86) PCT No.: PCT/FR2016/051600

§ 371 Date: Dec. 14, 2017

(30) Foreign Application Priority Data
Jun. 29, 2015 (FR) 1556081

(51) Int. Cl. G06T 7/00; G06T 7/11; G06T 7/136; G06T 7/155

(52) U.S. Cl. CPC G06T 7/0008; G06T 7/11; G06T 2207/30252; G06T 7/155; G06T 7/001; G06T 7/136

(57) ABSTRACT

A method of segmenting a grey-level image of a tire is provided. The image is segmented into a first zone that includes striations and a second zone that does not include striations. In a flattening step, the grey-level image is rendered flat. In a thresholding step, the flattened grey-level image is transformed into a binary image. In a detection step, lines of the binary image that include striations are detected. In an evaluation step, a number of striations on each line detected in the detection step is evaluated. In a pixel determination step, based on results of the detection and evaluation steps, a number of striations in the binary image is obtained and a first set of pixels of the binary image is determined. The first set of pixels represents striations in the binary image.

### FIELD OF THE INVENTION

The invention relates to the field of the manufacture of tires, and more particularly the field of visual checking of the latter in the course or in the end of the production process.

The visual inspection of the tires is widely developed in the tire industry and usually calls upon the dexterity of the operators responsible for detecting these possible imperfections visible on the surface of the tire. However, with advances in the processing power of computing means, manufacturers are now glimpsing the possibility of automating these checking tasks.

For this purpose, various lighting and digital imaging means are therefore used to acquire images of the tires, with a view to subsequent digital processing making it possible to detect imperfections previously detected visually by operators.

These imaging means make it possible to perform various captures of images, be it in two dimensions or in three dimensions, of the interior and/or exterior surface of the tire to be inspected.

Tires comprise certain zones in which striations are present, and other zones not exhibiting any striations. These striations generally exhibit a width of the order of a few millimetres, and a height of the order of a millimetre. To detect certain defects in tires, it is useful to be able to apply different processings to the striated zones and to the non-striated zones. For this purpose, it is useful to be able to differentiate, on an image of a tire, the various zones that are present.

Various techniques aimed at performing such differentiation are known, but none exhibits sufficient robustness to be used in a field such as that of the checking of tires. Indeed, it has for example been found that the welds present on a tire would falsify the segmentation performed by prior art methods. Furthermore, the known solutions exhibit processing times that are too long to be acceptable in an industrial environment.

The present invention is therefore aimed at proposing a segmentation solution making it possible to remedy the above-mentioned drawbacks.

### GENERAL DESCRIPTION OF THE INVENTION

The present invention is therefore aimed at proposing a method making it possible to segment a tire image so as to distinguish the zones exhibiting striations from those not exhibiting any.

Thus, the present invention relates to a method of segmenting an image, representative of a manufactured product whose external surface exhibits relief patterns, into a first zone comprising patter ns and a second zone not comprising any, the method comprising the following steps:
A step in the course of which the image is rendered flat,
A thresholding step in the course of which the grey level image is transformed into a binary image,
A step of detecting the lines of the image comprising striations, and
A step of evaluating the number of striations on each line, and
A step in the course of which, as a function of the results of the previous steps which make it possible to obtain a number of striations in the image, a first set of pixels of the image representing striations is determined.

Hereinafter in the patent application, an image on which a method in accordance with the invention is applied will sometimes be referred to by the expression “input image”.

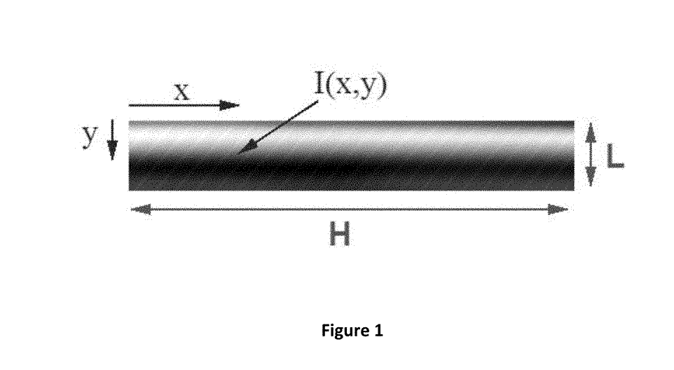

By convention, throughout the patent application, the notations shown in FIG. 1 will be used. Thus, the notations L and H will be used respectively for the width and the height of an input image, and the point I(x,y) will be referenced in the reference frame (x,y) shown in this figure.

It has been found that certain input images possessed a curvature along the lines and columns. This curvature appears on measuring the average of the lines and columns of the image: each line, and each column of the image, possesses a different average, correlated with its position in the image. This effect, due to the natural curvature of the tire, (which differs according to the type of tire) as well as to the mechanical stresses undergone by the tire during its acquisition, must be corrected before any other processing, so that all the elements of the tire have a comparable height whatever their position in the tire.

For this purpose, in a particular embodiment, the step of rendering the image flat comprises a step of detecting a carrier signal on which the striations lie. Accordingly, a simple moving average is carried out along the lines: at each pixel of the cleaned image the average of the neighbouring pixels (situated less than a certain distance away) and situated on the same line is calculated; this value is thereafter deducted from the pixel.

These operations can be defined in the following manner: Let I be a two-dimensional image, and r a positive integer, the operation AvgSub is defined to be a function taking a two-dimensional image I as input and producing an image of the same size as output and

AvgSub,(I)(x,y)=l(x, y)−μ({I)(l, y)|l ∈|0,L(I)| and min(|x−1), L(I)−|x−1|)≤r})

The operation consists in calculating, in a horizontal window of size 2r+1 centred on the pixel (x; y), (by considering the specific feature, expressed by the minimum, of stitching together the right and left edges), the average of the pixels, and deducting this average from the value of the pixel (repeating this for all the pixels of the image).

The method of segmentation of the present invention could also be used on images representing all types of object, and not necessarily tires. In this case, the step of rendering flat would not turn out to be definitely useful since, in the case of a tire, it is made necessary because of the rounded shape of the object.

In a preferential manner, the image rendered flat, that we shall henceforth call the “flat image”, is obtained by subtracting the minimum of the image from this average value so as to obtain solely positive values. For the latter operation, a radius is advantageously chosen which makes it possible to preserve the striations while removing the carrier. Furthermore, it turns out that, although carried out solely on the lines of the image, this operation also makes it possible to circumvent the curvature along the columns of the image.

Once the input image has been rendered flat, the following step of the method consists in performing a thresholding operation, so as to transform the flat image, which is in grey levels, into a binary thresheld image. This makes it possible to create an output mask comprising as a first set of pixels containing the striations, and a second set of pixels comprising the other elements.

To decide whether a pixel belongs to the output mask, three criteria are verified:
The first two consist in calculating on the one hand the average of the grey levels of the set of pixels of the line (respectively of the column) on which a pixel is situated, on the other hand the standard deviation, and to add these two values together.
The third criterion consists in verifying that the pixel belongs to a valid line, that is to say a line which is not too close either to the top, or to the bottom of the image; or a line which does not contain too large a number of outlier values, or else again a line which is not too close to a line containing a large number of outlier values.

As a function of the output mask thus defined, it is then possible to detect, in the image rendered flat, the lines in which striations are present. On completion of this detection, a one-dimensional image is obtained, of the same size as the height of the flat image.

This detection step is performed in the following manner:
the variance of the grey levels of the pixels not belonging to the binary thresheld image is calculated, for each line of the image rendered flat, this amounting to excluding the striations possible,
the calculation is performed a second time while horizontally expanding the thresheld image, this amounting to excluding more pixels from the calculation.

The lines on which striations are present in the flat image will exhibit a very different result from the other lines. Indeed, the variance calculation performed excludes the cast shadow phenomenon caused by the striations, this leading to low values with respect to the average. Thus, the lines comprising striations will exhibit a large difference between the two variance values, whilst such is not the case for the lines with no striation.

The ratio between the two variance values thus calculated is then computed for each line. If this ratio becomes greater than a predetermined threshold, it will be considered that the line comprises a striation.

It is remarked here that a specific feature of striations, namely the cast shadow phenomenon, is used to detect them. Other schemes could be envisaged for carrying out this detection step, however it has been found that the scheme described here provided the best results.

It should be noted once more that this step of detecting striations is made necessary by the specific character of the object, namely a tire. Indeed, as indicated previously, the striations are due to the method of manufacture, and can therefore be interrupted and therefore present only on a part of the lines. Hence the need to detect the lines which contain striations. This step would therefore not be necessary in the case of application to another type of object.

The following step, in a method in accordance with the invention, consists in evaluating the number of striations on each line. Accordingly, the following steps are implemented:
firstly, the variance is calculated along each of the columns of an input image, so as to construct a one-dimensional image possessing a similar regularity to the striations. According to the examples, the flat image or the thresheld image will be chosen as input image.
Two successive Fourier transforms are applied to this one-dimensional image so as to obtain a decomposition of the image in the frequency space,
one or more maxima of the decomposed image is or are then sought. Indeed, if an abscissa value x is high, this signifies that in the image there is a pattern which repeats itself every x pixels. Consequently a maximum of the image can correspond to a period of striations.

However, it has been found that in certain cases, a maximum of the decomposed image does not correspond to a sought-after period of the striations, but to a harmonic, that is to say a value due to a group of striations which repeats itself regularly in the image. Consequently it is useful, in a particular embodiment, to look at the fractions of the determined maximum to detect possible candidates for the period of the striations.

In a last step of a method according to the invention, the best components that could be striations are detected in the thresheld image, and they are retained in a Result set. Accordingly, the adjoining components of the thresheld image are traversed by decreasing size, and they are retained if two conditions are complied with:
Firstly, it is not necessary that the adjoining component, if it was added to the Result set, should lead to there being on a line of the thresheld image a greater number of elements of the Result set than the number of striations that was detected in the previous step, and
It is necessary furthermore that the adjoining component should belong to a valid line such as defined in paragraph [0019].

On completion of the latter step, a first pixel set is then obtained, corresponding to the Result set, comprising the set of striations of the image.

However, it has been found that the Result set could, in certain cases, comprise supernumerary elements, which it would be useful to remove. For this purpose, in one embodiment, a method according to the invention furthermore comprises the following steps:
a step of re-evaluating the number of striations in the image, and
a step of filtering the determined set of pixels, as a function of the re-evaluated number of striations, so as to obtain a second set of pixels of the image.

In another embodiment, a method according to the invention furthermore comprises a step in the course of which empty spaces of the image are filled in so as to obtain a third set of pixels of the image.

In one embodiment, a method according to the invention comprises a step in the course of which supernumerary components are eliminated from the third set of pixels so as to obtain a fourth set of striations of the image representing striations.

It has been found that slight noise present in the image to which the method is applied could disturb the detection of the striations, and thus lead to poor segmentation. To remedy this, in one embodiment, it is useful to provide a prior step of cleaning the image with morphological filters. Let us consider, in a particular example, an image where the topography of a tire is represented, that is to say that the value of each pixel of the image represents the height of the neighbourhood of the corresponding point in the tire. In such an image, the high grey level values indicate pixels of high altitude, while the low grey level values indicate pixels of low altitude. Thus, the striations present on a tire resemble, in a topographical image, extended mountain chains, without necessarily being very high, while the noise present in the image appears in the form of a spike of very (mountains) or very low (canyons) altitude but of small size.

The objective of the present step is therefore to remove these spikes in value. For this purpose, use is made of a morphological opening, which consists in removing all the narrow mountains, whatever their altitude, followed by a morphological closing which consists in removing all the narrow canyons, whatever their depth.

The opening operation consists firstly in replacing the value of each pixel of the image with the minimum value of the pixels situated in a certain neighbourhood, and then in recommencing the operation, this time taking the maximum value. The closing operation consists in carrying out the same two operations, but in reverse (firstly the maximum value, and then the minimum value). The chosen neighbourhood consists of the set of pixels situated on the same line, as the pixel studied (one then speaks of opening and closing by a linear structuring element) and at a distance less than a certain threshold.

A threshold value making it possible to eliminate, on each line, mountains and canyons of small size, is preferentially chosen. However, this choice of radius must represent a compromise between too low a value which would not allow correct cleaning, and too high a value which could lead to the removal of certain elements of interest of the striations.

### DESCRIPTION OF THE BEST EMBODIMENT

The detail of each of the steps of the scheme will be described hereinafter. In the description of this embodiment, the relief patterns will be called striations. In this example, the cleaning step is performed beforehand. Thus, if the starting image is named CEA, the cleaned image will be:

Clean=ϵ₈ ^{H̊}(y_{S}^{H̊}(CEA)) (1)

As described previously in this text, the step of rendering flat is performed using an operation AvgSub

AvgSubᵣ(I)(x, y)=I(x, y)−μ({I(l, y)|l ∈|0, L(I)|and min(|x−1), L(I)−|x−1|)≤r})

The following calculation is then performed: in a horizontal window of size 2r+1 centred on the pixel (x; y), the average of the pixels is calculated, and to deduct the latter from the value of the pixel (repeating this for all the pixels of the image). In a preferential manner, the image rendered flat, which we will henceforth call the “flat image”, is obtained by subtracting the minimum of the image from this average value to obtain solely positive values:

Flat=AvgSub₁₀₀(Clean)−min(AvgSub₁₀₀(Clean)) (2)

The calculation of the thresheld image is performed in the following manner:
a function is constructed which makes it possible to allocate a label to each line y of the input image. If an input mask PNM is considered, representing the outlier values of the input image (the pixels of outlier value are at A, and the others are at 0, and two stages are undertaken: firstly, a first temporary one-dimensional image is defined, of the same size as the height of the input images, and such that:

$$Line\_tmp ( y ) = \{ \begin{matrix}Line\_NOTOK \_PNM if y < 10 or H ( PNM ) - y \leq 10 \\ Line\_NOTOK \_PNM if \frac{\vert PNM (* , y ) \vert}{L ( PNM )} > 5 \% \\ Line\_OK otherwise\end{matrix}$$

The first condition makes it possible to mark as invalid the first ten and the last ten lines of the image, and the second condition makes it possible to mark as invalid all the lines possessing more than 5% of pixels marked as outliers in the image PNM.
We put Line_NOTOK_PNM=0 and Line_OK=2. The image Line, which will give us the label of each line, is obtained by propagating the labels of invalid lines, by virtue of an erosion, as follows:

Line=ϵ₂₀^{H}(Line_tmp) (3)
It is then possible to define the output mask by carrying out a threshold based on our previously defined criteria and on the labelling of the lines, on the basis of the image previously rendered flat (see equation 2)
This formula produces at output a mask of size equal to the size of the images at input, and where a pixel will be present if it is on a valid line (first condition), if its value is greater than the average plus the standard deviation of the pixels of the same line as it (second condition), and if its value is greater than the average plus the standard deviation of the pixels of the same column as it (third condition).

The step of detecting lines comprising striations is performed in the following manner:
We begin by calculating, for each line y of the image rendered flat (see equation 2), the variance of the pixels not belonging to the thresheld image, and the variance of the pixels not belonging to the expanded thresheld image of 60 pixels,:

V(y)=Var((Flat(x, y) (Thresh(x, y)=0))

Vₓ(y)=Var((Flat(x, y) |δ₆₀^{H}(Thresh)(x, y)=0))
As explained previously, the ratio between these two values is calculated, in a new one-dimensional image Score, of size equal to the height of the input images. The ratio between the two values is also calculated in the one-dimensional image Ratio, but while undertaking cleaning with the aid of openings and closings, in the following manner:

$$Score ( y ) = \frac{V}{{V}_{δ}} \\ Ratio ( y ) = \frac{{φ}_{10}^{H} ( {γ}_{10}^{H} ( V ) )}{{φ}_{10}^{H} ( {γ}_{10}^{H} ( {V}_{δ} ) )} \qquad ( 5 )$$

We shall employ the image Ratio hereinafter in this section, whereas we shall employ the image Score in the following sections. For each valid line of the image, a search is conducted (by employing the image Line defined in equation 3), for the two extrema of values of Ratio.

$$min\_Ratio = {min}_{{l ∈ \vert 0 , H ( Flat ) \vert}_{Line ( l ) = Line \_ OK}} Ratio ( l )$$

$$max\_Ratio = {min}_{{l ∈ \vert 0 , H ( Flat ) \vert}_{Line ( l ) = Line \_ OK}} Ratio ( l )$$

After much experimentation, we have established that the variance ratio threshold which acts as limit is 1.5: if the value min_Ratio is greater than this threshold, then it is considered that the striations are present on all the lines of the image, if the value max_Ratio is less than this ratio, then the image does not possess any striations.
What is more complicated to determine happens when these two extrema are situated on either side of the threshold. In this case, the value of 1.5 no longer plays the role of satisfactory threshold, and it is necessary to find another threshold, differing according to the images. Our technique consists in choosing a threshold value s in such a way as to divide the lines of the image into two classes (with striation, it is assumed, and without striation, it is assumed) in such a way that the variances of the two classes are very close (this procedure is discussed hereinafter):

$$s = {arg min}_{t} \vert Var \{ Ratio ( i ) \vert Ratio ( i ) \leq t \} - Var \{ Ratio ( i ) \vert Ratio ( i ) > t \} \vert$$

If several thresholds are candidates to be the minimum, the lowest threshold will be taken.
It is possible to construct the image Line2_tmp which allocates a label to each of the lines of the input image by allocating, for all yϵ[0, H (Flat)]

$$Line2\_tmp ( y ) = \{ \begin{matrix}Line\_NOTOK \_NOSTRILE if Ratio ( y ) \leq s \\ Line\_OK otherwise\end{matrix}$$

We put Line_NOTOK_NOTSTRIATION=1.
The final image Line2, which allocates the definitive label of each of the lines of the input image, is a mixture between Line and a cleaned version of Line2_tmp. For all yϵ[0, H (Flat) [: we put

$$Line 2 ( y ) = \{ \begin{matrix}Line ( y ) if min\_Ratio > 1.5 \\ min \{ Line ( y ) , {ϵ}_{10}^{H} {φ}_{10}^{H} {γ}_{10}^{H} ( Line2\_tmp ) \} otherwise\end{matrix} \qquad ( 6 )$$

As explained previously, the image Line2 which allocates a label to each line of the input image is composed by mixing the information of Line and of Line2_tmp. If all the lines have a satisfactory variance ratio (greater than 1.5), then the striations are present over the entire height of the image and Line2 will be a copy of Line. Otherwise, if only certain lines have a satisfactory variance ratio, then Line2 is equal to a cleaned version of Line2_tmp except for the lines comprising too many outlier values, where the label Lin_NOTOK_PNM is recopied (this operation is carried out by virtue of using the minimum);
The cleaning of Line2_tmp is performed by virtue of an opening, followed by a closing. However, it is realized in the images partially comprising striations that the latter do not all come to a stop on the same line: they peter out gradually, and do not disappear at the same lines. For this reason, an erosion of Line2_tmp is performed so as to widen the labels of the striation-less lines and to include, as a precaution, these “fuzzy” zones as striation-less lines.

The step of evaluating the number of striations on each line is preferentially performed in the following manner:
The variance is calculated of each of the columns of an input image Input which is, according to the embodiment, the image rendered flat Flat or the thresheld image Threshold. This calculation is performed by excluding, by virtue of Line2, the elements situated on lines possessing no striations. Furthermore, an erosion of the elements of Line2 is performed beforehand so as to distance the valid line labels from these zones:

Var_col(x)=Var(Input(c, y)|ϵ₁₀^{H}(Line2(y))=Line_OK)
The image Var_col thus obtained is a one-dimensional image of the same size as the width of the images input. It is found that this image possesses a pattern that repeats as many times as there are striations in the image. A Fourier analysis of this image Var_col will then be performed to find the number of present striations on each line of the image. This calculation is as follows:

F =Ht(Ht(y₁₀^{H}ϕ₁₀^{H}(Var_col)))
The size of the image F is equal to the largest power of two that is strictly less than L(Input) plus 1. Thus, for images 40,000 pixels wide, F has 32769 pixels. The image F is such that a spike on F(1000) signifies that there is, in the image, a pattern referencing itself every 1000 pixels. Consequently, it is useful to search for the spikes of E However, beforehand, the image is cleaned with an opening and a closing as follows:

F2y₁₀^{H}ϕ₁₀^{H}(F)
It is found that the structure of F2 is often the same whatever the input image: in a first third of the image, interesting oscillations are observed placed on a carrier signal, then the signal remains flat, dips towards half the image, and climbs back a little to remain flat in the last half. We shall therefore search for the minimum of the image after the first third, and place Os after this minimum, to obtain an image F3 as follows:

$$m = {arg min}_{x} \{ F 2 ( x ) \vert x \geq \frac{1}{3} L ( F 2 ) \}$$

$$F 3 ( x ) = \{ \begin{matrix}F 2 ( x ) if x \leq m \\ 0 otherwise\end{matrix}$$

A geodesic reconstruction of an image D in F3 is performed thereafter so as to recover the carrier signal that can then be removed. The image D is an image of the same size as the image F3, having as value at all the points except at the abscissa 0 where it equals F3(0).
We then search for the position of the maximum of F4:

$${p}_{m} ax = {arg max}_{x} F 4 ( x )$$

It has been found that this maximum did not always represent the spatial period of the striations in the image. Indeed, it is necessary to take account of the phenomenon of harmonics in the image. For this purpose, we shall test fractions of the previously determined maximum, and search for a maximum pₙ of F4 in a certain neighbourhood Rn as follows:

$${R}_{n} = \{ x ∈ \vert 0 , L ( F 4 ) \vert \vert \vert x - ⌊ \frac{{p}_{max}}{n} ⌋ \vert \leq 100 \}$$

$${p}_{n} = {arg max}_{x ∈ {R}_{n}} F 4 ( x )$$

The set Nb_striation is then constructed, which contains all the candidates for the number of striations in the image:

$$Nb\_Striation \{ ⌊ \frac{L ( Input )}{{p}_{n}} ⌋ \vert n ∈ [ 1 , 10 ] ⋂ ℕ and \\ L 4 ( {p}_{n} ) \geq 0.3 * L 4 ( {p}_{max} ) \} \qquad ( 7 )$$

The step of detecting the best candidates of the binary image is performed as follows:
Let C be the set of the adjoining components of Threshold; C′ the set of the elements of C which appear on at least 20 lines labelled as valid, and let S be the sequence of the elements of C′ sorted by decreasing size. We then have:

$$\{ \begin{matrix}For all k ∈ [ 1 , q ] , \\ {C}_{k} ∈ {C}^{′} ↔ \vert \{ l ∈ \vert ystart ( {C}_{k} ) , yend ( {C}_{k} ) \vert \vert Line 2 ( ) = Line\_OK \} \vert \geq 20\end{matrix} \\ \{ \begin{matrix}For all i ∈ [ 1 , p ] , {S}_{i} ∈ {C}^{′} \\ For all i , j ∈ [ 1 , p ] , i < j ↔ \vert {S}_{i} \vert \geq \vert {S}_{j} \vert and {S}_{i} \neq {S}_{j}\end{matrix}$$

The set Candidate is then constructed by adding the elements of S if they are not in conflict with the elements already added to Candidate. Accordingly, a series of set R is constructed:

$${R}_{0} = 0 \\ {R}_{i} = \{ \begin{matrix}\begin{matrix}{R}_{i - 1} ⋃ \{ {S}_{i} \} if , for all j ∈ [ ystart ( {S}_{i} ) , yend ( {S}_{i} ) ] , \\ {nb\_comp}_{Thresh} ( {R}_{i - 1 , j} ) < nb\_striation\end{matrix} \\ {R}_{i - 1} otherwise\end{matrix} \\ Candidate = {R}_{k} \qquad ( 8 )$$

Finally, the present invention proposes a method implementing a certain number of original characteristics with respect to the solutions known from the prior art.

Thus, the means making it possible to perform a detection of the lines of the image where striations are present are different from the known solutions, since the principle consisting in taking a mask of pixels that are candidates to belong to striations, and in observing how the variance (calculated by excluding the elements of this mask) evolves as a function of the expansion of this mask, is original. Indeed, in the present invention, a search is conducted for relief elements which cause a projected shadow on the image, and the lines of the image possessing striations are detected by attempting to detect the lines possessing a cast shadow.

Moreover, the present invention is aimed at proposing a method making it possible to divide the lines of the image into two categories: those where striations are present, and those not possessing any. It has been found that the known solutions, namely the conventional approach consisting in minimizing the intra-class variance or in maximizing the inter-class variance did not work (in particular since the classes can have large variances). In the present invention, use is made of means consisting in equalizing the variances of the classes with the aid of an algorithm in linear time, thereby making it possible to remedy the drawback of the known solutions.

Furthermore, the scheme for counting the striations, making it possible to ascertain how many striations are normally present on the image in the absence of any defect comprises two inventive elements:
The first resides in the fact of carrying out a Fourier transform not on each line of the image, as presented in the known solutions, but on a signal in one dimension, which signal is representative of the lines of the image. This signal is obtained by calculating the variance of each column of the image: by virtue of the relief of the striations and their cast shadow, a signal with the same period as the striations of the image is obtained. This solution makes it possible to decrease the calculation times implemented.
   The second element stems from the fact of carrying out morphological operations on the results of the Fourrier transform so as to clean it of parasitic elements which could falsify the result obtained.
   Finally, a method according to the invention implements, for selecting the best candidate components that could belong to a striation, a series of operations of placement and then removal of the candidates while decreasing the constraints on their position as one proceeds. This process of decreasing the constraints as one proceeds runs counter to all the solutions of the prior art which generally consist in increasing the constraints with time.

1-6. (canceled)

7. A method of segmenting an image of a tire into a first zone that includes striations and a second zone that does not include striations, the method comprising:
a flattening step of rendering flattened a grey-level image of the tire, to obtain a flattened grey-level image;
a thresholding step of transforming the flattened grey-level image into a binary image;
a detection step of detecting lines of the binary image that include striations;
an evaluation step of evaluating a number of striations on each line of the lines detected in the detection step; and
a striation determination step of, based on results of the detection step and the evaluation step, determining a number of striations in the binary image and determining a first set of pixels of the binary image, wherein the first set of pixels represents striations in the binary image.

8. The method according to claim 7, wherein the flattening step includes detecting a carrier signal on which striations lie.

9. The method according to claim 7, further comprising:
a re-evaluation step of re-evaluating the number of striations in the binary image, to obtain a re-evaluated number of striations; and
a pixel removal step of filtering the first set of pixels as a function of the re-evaluated number of striations, to obtain a second set of pixels of the binary image.)

10. The method according to claim 8, further comprising:
a re-evaluation step of re-evaluating the number of striations in the binary image, to obtain a re-evaluated number of striations; and
a pixel removal step of filtering the first set of pixels as a function of the re-evaluated number of striations, to obtain a second set of pixels of the binary image.)

11. The method according to claim 9, further comprising a space filler step of filling empty spaces of the binary image, to obtain a third set of pixels of the binary image.

12. The method according to claim 10, further comprising a space filler step of filling empty spaces of the binary image, to obtain a third set of pixels of the binary image.

13. The method according to claim 11, further comprising a supernumerary removal step of eliminating supernumerary components from the third set of pixels, to obtain a fourth set of pixels of the binary image, the fourth set of pixels representing striations.

14. The method according to claim 12, further comprising a supernumerary removal step of eliminating supernumerary components from the third set of pixels, to obtain a fourth set of pixels of the binary image, the fourth set of pixels representing striations.)

15. The method according to claim 7, further comprising, before the flattening step, a filtering step of cleaning the grey-level image with morphological filters.)

16. The method according to claim 8, further comprising, before the flattening step, a filtering step of cleaning the grey-level image with morphological filters.)

17. The method according to claim 9, further comprising, before the flattening step, a filtering step of cleaning the grey-level image with morphological filters.

18. The method according to claim 10, further comprising, before the flattening step, a filtering step of cleaning the grey-level image with morphological filters.

19. The method according to claim 11, further comprising, before the flattening step, a filtering step of cleaning the grey-level image with morphological filters.

20. The method according to claim 12, further comprising, before the flattening step, a filtering step of cleaning the grey-level image with morphological filters.

21. The method according to claim 13, further comprising, before the flattening step, a filtering step of cleaning the grey-level image with morphological filters.

22. The method according to claim 14, further comprising, before the flattening step, a filtering step of cleaning the grey-level image with morphological filters.)

23. The method according to claim 7, further comprising a defect determination step of determining a variance between a result of the striation determination step and predetermined data for a normal tire.
